(19) United States
(12) Patent Application Publication
(10) Pub. No.: US 2017/0018035 A1
(43) Pub. Date: Jan. 19, 2017

(54) Method for Authenticating Income Tax Forms

(71) Applicant: Jamal Darad Shakir, Smyrna, GA (US)

(72) Inventor: Jamal Darad Shakir, Smyrna, GA (US)

(21) Appl. No.: 14/797,376

(22) Filed: Jul. 13, 2015

(51) Int. Cl. G06Q 40/00; G06K 9/78; G06T 7/00; G06K 9/00

(52) U.S. Cl. CPC G06Q 40/123; G06K 9/00449; G06K 9/00483; G06K 9/78; G06T 7/0002; G06T 2207/30176

(57) ABSTRACT

A method for authenticating various tax forms to a high degree of accuracy in order to prevent tax fraud. The method is implemented on a computer and includes first receiving a plurality of verified tax forms from an at least one employer account and trusted database. The plurality of verified tax forms are then stored on an authenticated database. One of the inputs for the method is a verification request from a user account, wherein the verification request includes an unverified tax form. The method compares pre-selected data entries of the unverified tax form against corresponding data entries for each of the plurality of verified tax forms in order to identify an identical match. If the identical match is identified, then a verification notification is sent to the user account. Conversely, if the identical match is not found, then a rejection notification is sent to the user account.

### FIELD OF THE INVENTION

The present invention relates generally to a method for verifying the authenticity of various tax forms. More specifically, the present invention is a software application that quickly and efficiently verifies the authenticity of W2 and 1099 income tax forms by comparing the user submitted forms/information with the employer submitted forms/information.

### BACKGROUND OF THE INVENTION

In the U.S. millions of taxpayers are required to submit tax return forms to state and federal level governments every year in order to check for tax liabilities and payments. These forms allow the taxation authority to evaluate the taxpayer's standing in respect to state and government taxes. The Internal Revenue Service (IRS) requires an information return to submitted by both the taxpayer and any entity which has paid income to said taxpayer to ensure that the submitted report is accurate. Regardless of this check, every year billions of dollars are issued in fraudulent tax refunds. The majority of the losses is due to identity theft tax return fraud. Tax return fraud is when an individual uses someone else's personal information, without permission, to obtain the individual's tax refund; personal information includes name, personal identification, and or social security number (SSN). Identity theft is ranked among the top tax scams in the U.S. and is responsible for the loss of billions of dollars annularly. In addition, paperless e-filing has made it easier than before for scammers. Scammers simply submit someone else's personal information with phony wages and receive the fraudulent refund in the mail or through direct deposit in the least amount of time possible while it takes the IRS between four and six months to double-check and verify the submitted information against IRS records and employer-submitted information. By that time, the identity thief is long gone, leaving the IRS and the victim at a loss.

The aftermath of a tax refund fraud adversely affects a variety of entities such as the individual whose identity was stolen, the IRS, and any third party tax preparation company involved. The targeted individual must go through various processes in order to confirm their identity and collect their rightful tax refund, this may take anywhere between nine to twelve months. The IRS loses monetary funds in fraudulent refunds and in the additional time required to sort out fraudulent tax returns. Scammers often use third party companies to submit their fraudulent tax return. These companies do not have any efficient means for identifying fraudulent tax returns and resultantly are heavily scrutinized for it. This not only causes monetary losses for the company but it also negatively affects their credibility. The present invention provides a quick and efficient means for authenticating various tax forms that may be used by the individual taxpayer, the IRS, and the associated companies.

### BRIEF DESCRIPTION OF THE DRAWINGS

FIG. 1 is a flow chart depicting the overall process of the present invention.

FIG. 2 is a flow chart depicting the steps required to be taken in order to process a digital image of an unverified tax form.

FIG. 3 is a flow chart depicting the steps required to be taken in order to process data entries for the unverified tax form.

FIG. 4 is a flow chart depicting the steps required to be taken in order to allow the user account to choose pre-selected data entries for the unverified tax form.

FIG. 5 is a flow chart depicting the steps required to be taken in order to designate the complete set of data entries as pre-selected data entries for the unverified tax form.

FIG. 6 is a flow chart depicting the steps required to be taken in order to generate a correction notification describing dissimilar entries between the unverified tax form and the verified tax form.

### DETAIL DESCRIPTIONS OF THE INVENTION

All illustrations of the drawings are for the purpose of describing selected versions of the present invention and are not intended to limit the scope of the present invention.

The present invention is a method for authenticating tax return forms in order to prevent tax fraud. More specifically, the present invention is a software application for automatically analyzing tax return forms in order to determine their authenticity based on a multitude of data entries. In general, the present invention checks the authenticity of a tax return form by comparing the data entries within the tax return form against verified data from a trusted source, in particularly checking each and every data entry. The present invention may be used to check the authenticity of various Internal Revenue Service (IRS) tax forms including, but not limited to, the wage and tax statement W-2 form and the 1099 form. In one embodiment, the present invention may be integrated into various review processes of the IRS.

The method of the present invention is a software application executed by a computing device. The present invention is preferably integrated into a website that is hosted on at least one server and is accessible through the Internet. The server provides significant amounts of data storage to be used by the present invention. The user may access the website and, therefore, the present invention through a user device. The user device may be virtually any modern computing device which possesses an Internet connection and a user interface. Types of user devices includes, but is not limited to, desktop computers, laptop computers, smart phones, and tablet computers. Thus, the present invention may be easily accessible by users who have a wide range of different computing devices.

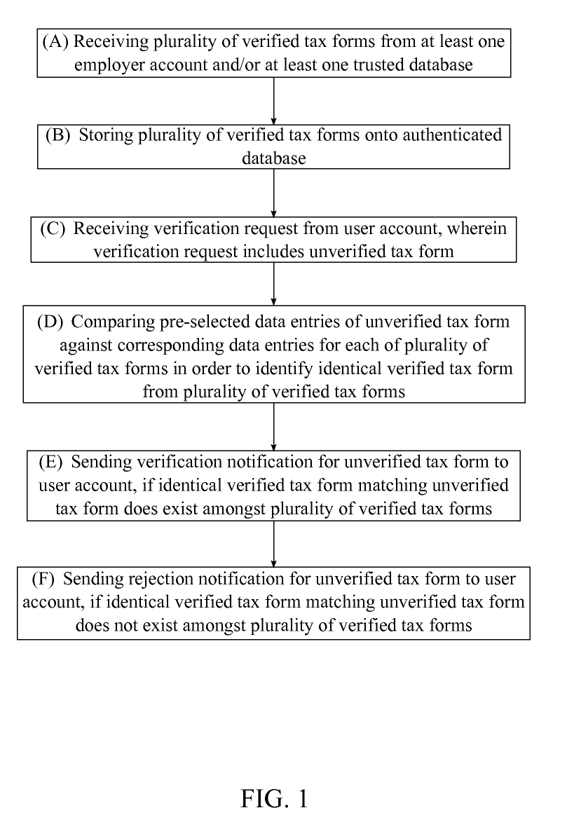

Referring to FIG. 1, the overall process for the present invention delineates the primary steps that need to be taken in order to determine the authenticity of a specific tax form. The overall process of the present invention begins with the system receiving a plurality of verified tax forms from an at least one employer account and or an at least one trusted database (Step A). Employer accounts are the means by which the present invention identifies specific users. Companies which participate in the present invention ensure that the tax forms submitted by their employees are authenticated. Trusted databases are accredited sources of information. The plurality of verified tax forms is then stored onto an authenticated database (Step B). It is preferred the plurality of verified tax forms is organized according to a tax filing year within the authenticated database. Once the plurality of verified tax forms is received, or in some cases collected, from the aforementioned sources, the present invention may then be used to authenticate unverified tax forms. The authentication process is initiated when the system receives a verification request from a user account, wherein the verification request includes the unverified tax form (Step C). The unverified tax form contains data entries such as name, address, social security number, income, and other similar content. The unverified tax form is received from the user account and contains information that has yet to be verified and may be false or incorrect. Conversely, the verified tax form is received from authenticated sources and contains correct/authenticated information. The verified tax form is used to check the quality and authenticity of the unverified tax form. The system then compares pre-selected data entries of the unverified tax form against corresponding data entries of the verified tax form for each of the plurality of verified tax forms in order to identify an identical verified tax form the plurality of verified tax forms (Step D). The identical verified tax form includes same data entries as the unverified tax form. If the identical verified tax form matching the unverified tax form does exist amongst the plurality of verified tax forms, then a verification notification is sent for the unverified tax form to the user account (Step E). This ensures that the information provided by the unverified tax form is correct which in turn verifies the identity of the submitting entity, thus preventing tax fraud and identity theft. Conversely, if the identical verified tax form matching the unverified tax form does not exist amongst the plurality of tax forms, then a rejection notification for the unverified tax form is sent to the user account (Step F). This is an effective means for identifying fraudulent documents and preventing tax fraud.

In order to accurately determine the authenticity of the unverified tax form, the present invention must populate the authenticated database with information obtained from a reliable source(s). To achieve this, all employer accounts are authenticated by a registered identification, the federal employer identification number (FEIN). The FEIN, also known as the federal tax identification, is a nine-digit number assigned by the IRS to business entities in the U.S. specifically for tax administration, making it the ideal candidate as a means for verifying the identity of the employer account. In alternative embodiments of the present invention, background investigations may also be used to authenticate the employer account; such investigations may be performed by the administrator of the present invention, an external private company, or a government agency. Furthermore, it is preferred that one of the trusted databases is managed by an official government source such as the IRS as the agency which reviews tax forms.

Tax forms such as the W-2 form and the 1099 form contain very sensitive personal information including, but not limited to, social security number, income, personal address, phone number, and wage. Therefore, network security is of high importance for the present invention. It is preferred that the plurality of verified tax forms and the unverified tax form are received through a secure line of communication. The secure line of communication may be achieved through data encryption and other similar methods. Information contained within the authenticated database is also preferably encrypted for additional security. Additional security measures may also be utilized by the present invention for further security.

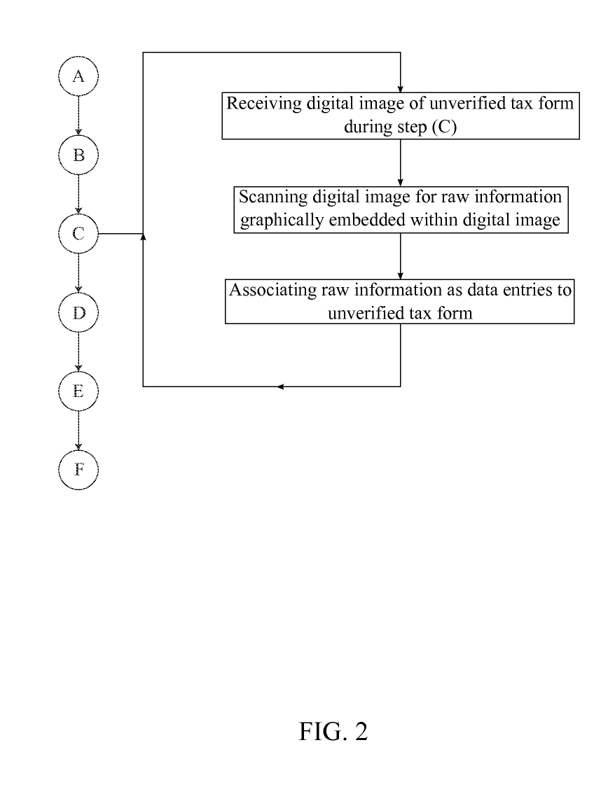

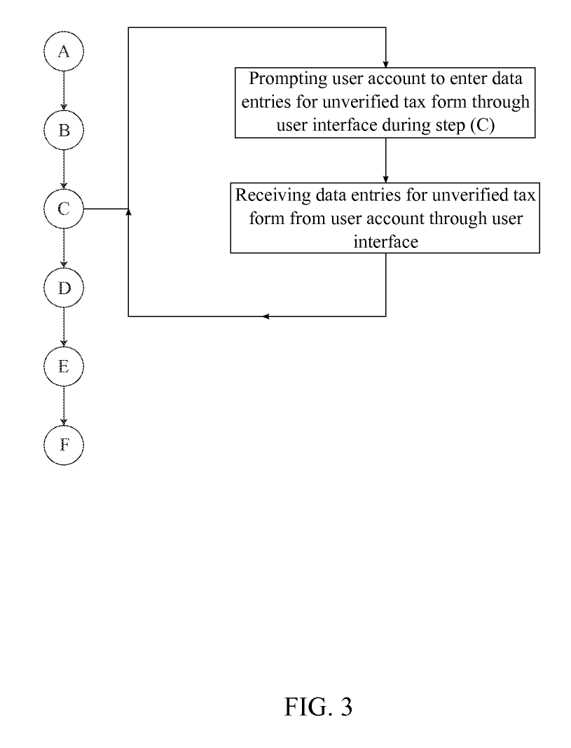

During Step C, the system allows the user account to submit either a digital image of the unverified tax form or enter data entries for the unverified tax form. The digital image may be obtained from a photograph or scanning of the unverified tax form. The alternative means of submitting the unverified tax form includes the system prompting the user account to enter the individual data entries for the unverified tax form. If the system receives a digital image of the unverified tax form, the system scans the digital image in order to extract the raw information graphically embedded within the digital image; essentially relating textual data to a corresponding visual representation, also known as optical character recognition. The raw information is then associated as the data entries to the unverified tax form and are compared against corresponding data entries for each of the plurality of verified tax forms as described in Step D as seen in FIG. 2. This compares the information submitted by the user account against information contained within the authenticated data base. The system also prompts the user account to enter data entries for the unverified tax form through a user interface as an alternative means for submitting the unverified tax form. This may be accomplished through the display of a series of input boxes to the user account, wherein each of the boxes contains an explanation for the required data entry: for example “enter name” or “enter social security number”. If the data entries from the user account through the user interface, then the system moves on to Step D of the overall process as seen in FIG. 3. Additional means for submitting the unverified tax form may also be implemented by the present invention including, but not limited to, mail, fax, and other forms of communication.

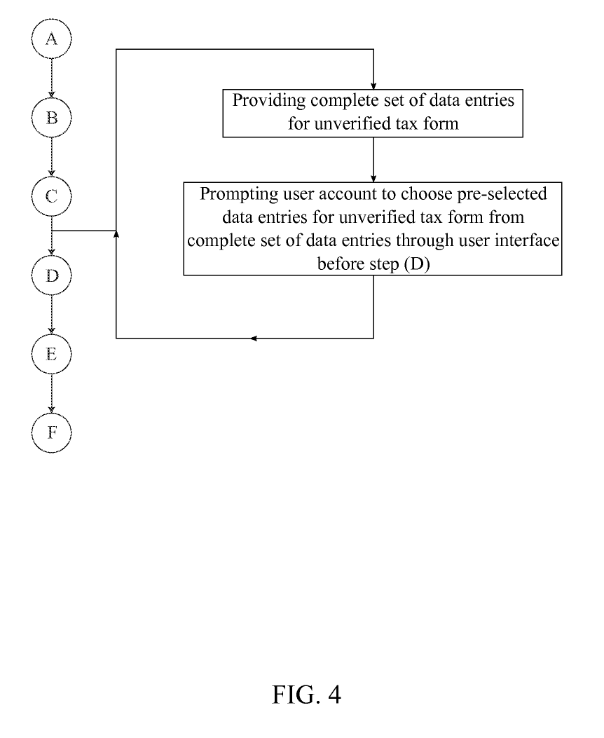

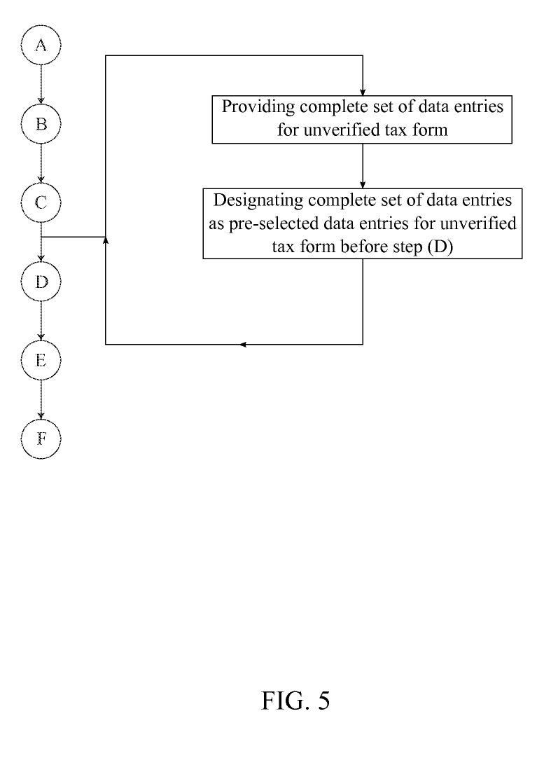

During Step D, the system compares pre-selected data entries of the unverified tax form against the corresponding data entries of the verified tax form for each of the plurality of verified tax forms in order to determine the authenticity of the unverified tax form. More specifically, the pre-selected data entries denote which data entries are used to during Step D. For example, if the pre-selected data entries comprise the social security number, name, and address, then the system only compares said entities and ignores all other data entries in the tax form. Providing that a complete set of data entries for the unverified tax form is received during Step C, the system prompts the user account to choose the pre-selected data entries for the unverified tax form from the complete set of data entries through the user interface prior to Step D as seen in FIG. 4. In one embodiment of the present invention, the complete set of data entries is designated as the pre-selected data entries for the unverified tax form prior to Step D as seen in FIG. 5. This configuration ensures the highest degree of authenticity for the unverified tax form as all of the data entries of the unverified tax form is checked by the present invention.

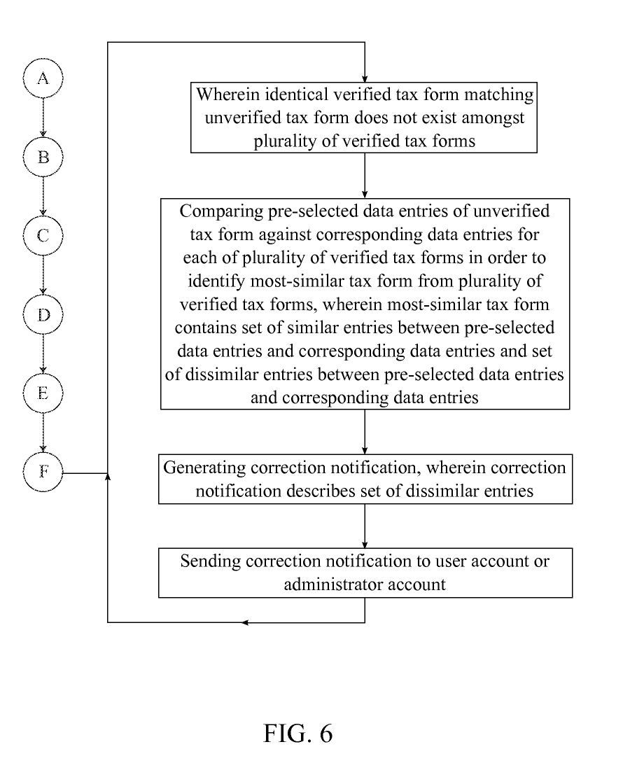

Referring to FIG. 6, in one embodiment of the present invention, if the identical verified tax form matching the unverified tax form does not exist amongst the plurality of verified tax forms, then the system sends not only the rejection notification but also information pertaining to the mismatching data entries to the user account, an administrator account, or another relevant entity. More specifically, the system compares the pre-selected data entries of the unverified tax form against the corresponding data entries for each of the plurality of verified tax forms in order to identify a most-similar tax form from the plurality of verified tax forms; the most-similar tax form contains a set of similar entries and a set of dissimilar entries between the pre-selected data entries and the corresponding data entries. The system then generates a correction notification and sends it to the user account or the administrator account; the correction notification describes the set of dissimilar entries. For example, if the set of similar entries includes the social security number, address, and name while the set of dissimilar entries includes income and withholding, then it may be seen as a red flag that may indicate a possible tax fraud attempt; the correction notification would notify the proper authorities about this situation. The correction notification may also be used to convey to the user account the incorrect data entries of his/her unverified tax form in order to facilitate the correct filing; in the case that they are minor information included in the set of dissimilar entries.

Although the invention has been explained in relation to its preferred embodiment, it is to be understood that many other possible modifications and variations can be made without departing from the spirit and scope of the invention as hereinafter claimed.

What is claimed is:

1. A method for authenticating income tax forms by executing computer-executable instructions stored on a non-transitory computer-readable medium, the method comprises the steps of:
(A) receiving a plurality of verified tax forms from an at least one employer account and/or an at least one trusted database;
(B) storing the plurality of verified tax forms onto an authenticated database;
(C) receiving a verification request from a user account, wherein the verification request includes an unverified tax form;
(D) comparing pre-selected data entries of the unverified tax form against corresponding data entries for each of the plurality of verified tax forms in order to identify an identical verified tax form from the plurality of verified tax forms;
(E) sending a verification notification for the unverified tax form to the user account, if the identical verified tax form matching the unverified tax form does exist amongst the plurality of verified tax forms; and
(F) sending a rejection notification for the unverified tax form to the user account, if the identical verified tax form matching the unverified tax form does not exist amongst the plurality of verified tax forms.

2. The method for authenticating income tax forms by executing computer-executable instructions stored on a non-transitory computer-readable medium, the method as claimed in claim 1, wherein creation of the employer account is authenticated by a registered identification.

3. The method for authenticating income tax forms by executing computer-executable instructions stored on a non-transitory computer-readable medium, the method as claimed in claim 1, wherein the trusted database is managed by an official government source.

4. The method for authenticating income tax forms by executing computer-executable instructions stored on a non-transitory computer-readable medium, the method as claimed in claim 1, wherein the plurality of verified tax forms and the unverified tax form are received through a secure line of communication.

5. The method for authenticating income tax forms by executing computer-executable instructions stored on a non-transitory computer-readable medium, the method as claimed in claim 1 comprises the steps of:
receiving a digital image of the unverified tax form during step (C);
scanning the digital image for raw information graphically embedded within the digital image; and
associating the raw information as data entries to the unverified tax form.

6. The method for authenticating income tax forms by executing computer-executable instructions stored on a non-transitory computer-readable medium, the method as claimed in claim 1 comprises the steps of:
prompting the user account to enter data entries for the unverified tax form through a user interface during step (C); and
receiving the data entries for the unverified tax form from the user account through the user interface.

7. The method for authenticating income tax forms by executing computer-executable instructions stored on a non-transitory computer-readable medium, the method as claimed in claim 1 comprises the steps of:
providing a complete set of data entries for the unverified tax form; and
prompting the user account to choose the pre-selected data entries for the unverified tax form from the complete set of data entries through a user interface before step (D).

8. The method for authenticating income tax forms by executing computer-executable instructions stored on a non-transitory computer-readable medium, the method as claimed in claim 1 comprises the steps of:
providing a complete set of data entries for the unverified tax form; and
designating the complete set of data entries as the pre-selected data entries for the unverified tax form before step (D).

9. The method for authenticating income tax forms by executing computer-executable instructions stored on a non-transitory computer-readable medium, the method as claimed in claim 1, wherein the plurality of verified tax forms is organized according to a tax filing year within the authenticated database.

10. The method for authenticating income tax forms by executing computer-executable instructions stored on a non-transitory computer-readable medium, the method as claimed in claim 1 comprises the steps of:
wherein the identical verified tax form matching the unverified tax form does not exist amongst the plurality of verified tax forms;
comparing the pre-selected data entries of the unverified tax form against the corresponding data entries for each of the plurality of verified tax forms in order to identify a most-similar tax form from the plurality of verified tax forms, wherein the most-similar tax form contains a set of similar entries between the pre-selected data entries and the corresponding data entries and a set of dissimilar entries between the pre-selected data entries and the corresponding data entries;
generating a correction notification, wherein the correction notification describes the set of dissimilar entries; and
sending the correction notification to the user account or an administrator account.
